(19) United States
(12) Patent Application Publication
(10) Pub. No.: US 2006/0243700 A1
(43) Pub. Date: Nov. 2, 2006

(54) COMPOSITE ELECTROFORMED SCREENING MASK AND METHOD OF MAKING THE SAME

(75) Inventors: Robert P. Rippstein, Hopewell Junction, NY (US); Harry D. Cox, Rifton, NY (US); James Kuss, Claverack, NY (US); Hsichang Liu, Fishkill, NY (US); Vincent A. LoVerso, Clintondale, NY (US); Krystyna W. Semkow, Poughquag, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 10/908,126

(22) Filed: Apr. 28, 2005

(51) Int. Cl. B44C 1/22

(52) U.S. Cl. 216/12; 216/100

(57) ABSTRACT

A copper core used in electroformed metal (EFM) masks is replaced with a copper/molybdenum/copper clad core (Cu/Mo/Cu). The copper cladding on the molybdenum enhances adhesion of electroplated nickel. The nickel is electro-deposited through a patterned resist template onto the copper clad molybdenum surface. The copper and molybdenum are etched by selective etchants that do not attack other non-etched layers, leaving a patterned nickel stencil on a high-strength supporting base.

### BACKGROUND OF THE INVENTION

1. Field of the Invention

The present invention relates to metal screening masks for applications such as semiconductor processing and packaging of electronic components. More specifically, the present invention relates to small dimensional electroformed nickel plated masks.

2. Description of Related Art

Metal masks are used to generate a screened metal pattern on ceramic greensheets for numerous applications, such as alumina and glass ceramic substrates, and the like. The function of the metal mask is to act as a stencil, in the same manner as a silk screen mask, where a pattern composed of a metal doped paste is transformed through the metal mask onto a ceramic sheet material, which may be used in the fabrication of interconnect wiring layers for integrated circuits. The metal masks may be formed by etching apertures or openings that correspond to a specific pattern on a metal sheet or foil. The use of metal masks in electronics manufacturing is primarily for forming metallization features.

These masks may be made by a sub-etch process or by a plate-up process (EFM masks). Generally, the plate-up process starts with a copper core that is patterned on both sides with resist, and electroplated with nickel. The resist is then stripped and the copper etched away. Wet etching, using a resist stencil pattern, is the most widely used technique for forming metal masks. Other techniques, including reactive etching and laser-assisted etching are shown to have advantages for mask fabrication.

Manufacturing yield for masks and mask life (pass factor) impact the overall cost of ceramic substrates. Furthermore, the increasingly demanding density of screened patterns for finer lines, vias, spacing, and the larger size of the masks, which have increased from 185 mm to 215 mm, require stronger masks, more resilient to mechanical deformation, dents, creases, and with lower distortion in radial error. Attempts to improve EFM masks have included double layer nickel (DLN) masks. While DLN masks have some of the attributes listed above, these masks are difficult to build due to differences in pattern distortion in the first and second nickel layers. Usage of nickel as part of the core material requires a nickel etch step that will also attack the electroplated nickel features of the EFM mask.

In Japanese Patent No. JP63203787A issued to Ono Yoshio, published on Aug. 23, 1988, entitled “PRODUCTION OF SUSPENDED METAL MASK PLATE,” an image is printed on a resist, which is then applied to one side of a copper-supporting sheet. Only the image part of the resist is removed to partially expose the copper of the sheet. The copper exposed part is then plated with nickel to form an image-forming layer of nickel. The image-forming layer is stuck to one side of a gauze material of reticulated stainless steel or the like and the whole surface of the gauze is coated with nickel. The sheet is then removed with an etching solution.

Since patterns in nickel masks are becoming finer, electroform masks, such as nickel plate-up processes, are preferred. However, pattern location is a fraction of the smallest dimension. Thus, it is desirable to make the core material stiffer, and allow for an efficient nickel-plating process.

Bearing in mind the problems and deficiencies of the prior art, it is therefore an object of the present invention to provide a metal mask that is more structurally resilient than current metal masks.

It is another object of the present invention to provide a metal mask having a stiff core material.

A further object of the invention is to provide a mask core material having a higher modulus of elasticity than a copper core, providing greater resistance to mechanical damage and deformation.

Still other objects and advantages of the invention will in part be obvious and will in part be apparent from the specification.

### SUMMARY OF THE INVENTION

The above and other objects, which will be apparent to those skilled in art, are achieved in the present invention, which is directed to a screening mask comprising: a molybdenum foil core; a copper layer on each side of the molybdenum foil core; and a nickel layer on each of the copper layers. The nickel layers may be electroformed, or may be patterned electroplated nickel. Portions of the copper layer not covered by the patterned electroplated nickel layer may be removed. Through-hole cavities through the mask may be defined by at least one etch process through the molybdenum foil core and the copper layers. The mask may further include at least one partial cavity defined by at least one etch process through at least a portion of the molybdenum foil core and at least one of the copper layers. The partial cavities may be etched at varying depths within the mask. The mask may further include at least one through-hole cavity defined by at least one etch process through the molybdenum foil core and the copper layers, and at least one partial cavity defined by at least one etch process through at least a portion of the molybdenum foil core and at least one of the copper layers. The preferred thickness of the molybdenum core is approximately 20 to 50 microns. The copper layer is approximately 2 to 5 microns thick. The nickel layer is approximately 20 to 40 microns thick.

In a second aspect, the present invention is directed to a screening mask comprising: a molybdenum foil core; and a nickel layer on each of the molybdenum foil core. The mask may include at least one partial cavity defined by at least one etch process through at least a portion of the molybdenum foil core. The mask may include at least one through-hole cavity defined by at least one etch process through the molybdenum foil core, and at least one partial cavity defined by at least one etch process through at least a portion of the molybdenum foil core.

In a third aspect, the present invention is directed to a method of making a screening mask comprising: bonding a copper layer to both sides of a molybdenum foil; patterning the copper layers with a photoresist; electroplating nickel into open areas between the patterned photoresist; striping the photoresist, leaving the electroplated nickel in a patterned sequence, the patterned sequence representing a predetermined pattern for the screening mask; removing portions of the copper layers between the nickel plating; and removing portions of the molybdenum foil. The copper layers are removed by a selective copper etchant, the copper etchant including ammonium chloride and cupric chloride basic solution. The molybdenum foil is removed by a selective molybdenum etchant, the molybdenum etchant including a potassium ferricyanide basic solution. The copper layers may be bonded to the molybdenum foil by hot rolling, metal evaporation, electroplating, or explosive plating. The copper layers may be cleaned using a commercial detergent. The method further includes a second photolithographic step to block removal of the copper layers in desired locations.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a molybdenum foil with a copper coating layer on each side, and patterned with a photoresist on both sides.

FIG. 2 depicts a patterned nickel structure formed over the molybdenum foil and copper layer structure of FIG. 1.

FIG. 3 depicts the mask of FIG. 2 after a copper etch process and identifies the areas of the specific copper layer removal.

FIG. 4 depicts a resulting mask cross-section showing a two-sided molybdenum wet etch through-hole and an etched cavity.

FIG. 5 depicts the mask of FIG. 4 with a resultant cavity formed by having the molybdenum etch process continued for a longer period of time.

FIG. 6 depicts a nickel-plated copper/molybdenum/copper mask with a cavity that exposes the copper layer.

### DESCRIPTION OF THE PREFERRED EMBODIMENT(S)

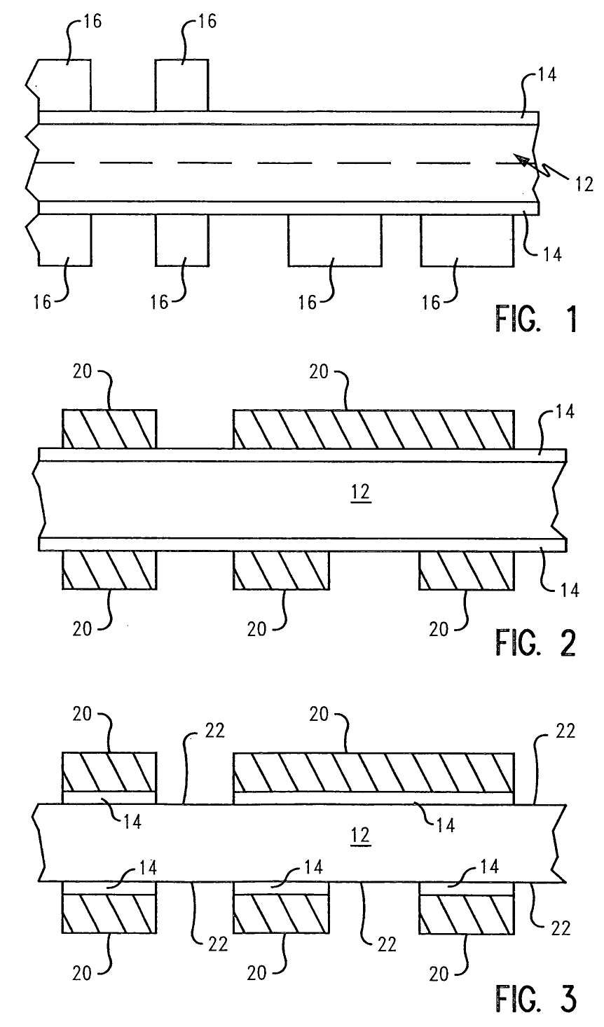

In describing the preferred embodiment of the present invention, reference will be made herein to FIGS. 1-6 of the drawings in which like numerals refer to like features of the invention.

Traditionally, a copper core is used in electroformed metal (EFM) masks. The present invention proposes replacing the copper core with a copper/molybdenum/copper clad core (Cu/Mo/Cu). The purpose of the molybdenum material is to impart resistance to deformation that occurs under plating stress and in robust manufacturing use, and to increase denting resistance. The copper cladding on the molybdenum enhances adhesion of electroplated nickel. This resultant clad material has a higher modulus of elasticity than a copper core alone, making it more resistant to mechanical damage and deformation.

The preferred process results in a nickel pattern formed by electrochemical deposition of nickel through a patterned resist template onto a copper clad molybdenum surface. The copper and molybdenum are etched by selective etchants that do not attack other non-etched layers, leaving a patterned nickel stencil on a high-strength supporting base. The preferred thickness the molybdenum layer is on the order of 20 to 50 microns. The preferred thickness of each copper layer is on the order of 2 to 5 microns; however, other thicknesses dedicated to specific applications are not precluded by this design. The preferred nickel layer is on the order of 20 to 40 microns thick. The high-resolution capabilities of the electro-formed nickel images are combined with the increased strength of the molybdenum core material to produce a mask with higher manufacturing survivability in ceramic screening applications.

The copper cladding aids adhesion of the electro-deposited nickel to the molybdenum. The copper clad molybdenum material is preferably fabricated by bonding the copper to the molybdenum in a hot rolling process or other commercially available process. Cladding of the copper layers to the molybdenum may also be achieved by metal evaporation, electroplating, hot rolling, or explosive plating. The copper surface is then cleaned, preferably using a commercial detergent.

A photoresist layer is applied to both top and bottom surfaces of a copper clad molybdenum sheet. Preferably, the photoresist layer thickness is made to exceed the predetermined thickness of the nickel layer. The photoresist is then patterned by normal exposure and development methods. FIG. 1 depicts a molybdenum foil 12 with a copper coating layer 14 on each side, and patterned with a photoresist 16 on both sides.

Nickel is then electroplated into the open areas between photoresist images. The photoresist is stripped by normal methods, leaving a patterned nickel structure 20 as shown in FIG. 2. A selective copper etchant is used to remove the copper layer located between the nickel images. FIG. 3 depicts the areas 22 of the copper layer removal. Removal of the copper is important since in the absence of the copper layer a subsequent molybdenum etchant will be able to reach the molybdenum surface. In practice, an ammonium chloride and cupric chloride basic solution may be used as a copper etchant. A molybdenum etchant is selected so as not to attack the copper or nickel layers. Preferred molybdenum etchants include potassium ferricyanide basic solution, but other etchants conducive to attacking molybdenum may be used as well provided they do not simultaneously attack the copper or nickel layers.

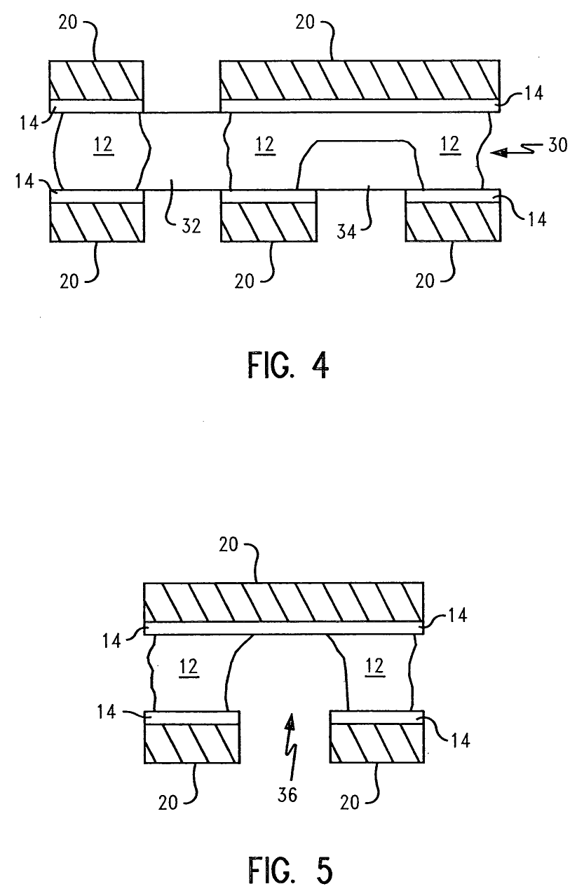

The molybdenum selective etchant is used to perform a two-sided molybdenum sheet etch. FIG. 4 depicts the resulting mask cross-section 30 showing a two-sided molybdenum wet etch through-hole 32 and an etched cavity 34. The etched cavity 34 is defined in part by approximately ½ of the molybdenum layer 12, the copper cladding layer 14, and the electroplated nickel layer 20. FIG. 5 depicts a cavity 36 that would result if the molybdenum etch process were continued for a longer period of time, exposing copper layer 14 under electroplated nickel layer 20.

The process for forming the screening mask of the present invention includes starting with a sandwich sheet of copper/molybdenum/copper (Cu/Mo/Cu). This sandwich sheet may be fabricated through any number of accepted methods known by those skilled in the art. The Cu/Mo/Cu sheet is then coated with a resist, which is exposed and developed to form a pre-selected pattern. Nickel is plated onto the copper on both sides of the Cu/Mo/Cu sheet through the resist pattern to form a nickel pattern, which ultimately represents the predetermined pattern for the resultant mask. The resist is then stripped, and the copper and molybdenum etched away using the plated nickel as a mask.

In a second embodiment, a layer of nickel is electroplated on molybdenum in lieu of the copper core. While electroplating nickel on molybdenum may be performed, an interface between molybdenum and nickel is typically not strong enough for many applications, and requires a high temperature heat treatment on the order of 550° C. However, using a layer of nickel instead of the copper core eliminates the need for a copper etch process.

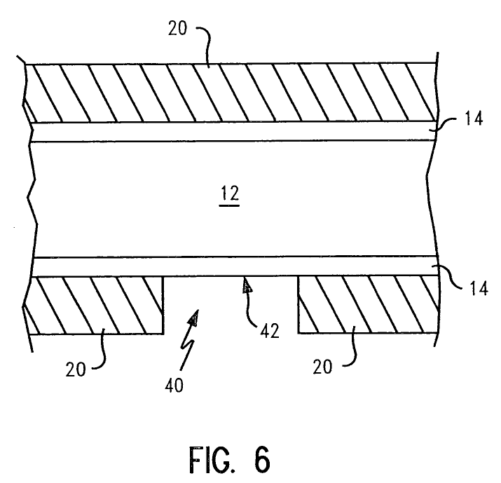

In a third embodiment, it may be beneficial not to remove the copper core layer. In this instance, the cavity 40 fabricated would have electroplated nickel sides and a copper layer bottom surface 42. FIG. 6 depicts a nickel-plated copper/molybdenum/copper mask with a cavity that exposes the copper layer. Consequently, it is within the purview of the present invention to fabricate a mask where several different cavity depths are simultaneously present. This technique may be useful for controlling paste deposition thickness for different size masks openings. It may be necessary to implement an additional photolithographic step to block removal of the copper layer in desired locations.

While the present invention has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

What is claimed is:

1. A screening mask comprising:
a molybdenum foil core;
a copper layer on each side of said molybdenum foil core; and
a nickel layer on each of said copper layers.

2. The mask of claim 1 wherein said nickel layers are electroformed.

3. The mask of claim 1 wherein said nickel layer is patterned electroplated nickel.

4. The mask of claim 3 wherein portions of said copper layer not covered by said patterned electroplated nickel layer are removed.

5. The mask of claim 1 including through-hole cavities through said mask defined by at least one etch process through said molybdenum foil core and said copper layers.

6. The mask of claim 1 including at least one partial cavity defined by at least one etch process through at least a portion of said molybdenum foil core and at least one of said copper layers.

7. The mask of claim 6 wherein said partial cavities are etched at varying depths within said mask.

8. The mask of claim 1 including at least one through-hole cavity defined by at least one etch process through said molybdenum foil core and said copper layers, and at least one partial cavity defined by at least one etch process through at least a portion of said molybdenum foil core and at least one of said copper layers.

9. The mask of claim 1 wherein the preferred thickness of said molybdenum core is approximately 20 to 50 microns.

10. The mask of claim 1 wherein said copper layer is approximately 2 to 5 microns thick.

11. The mask of claim 1 wherein said nickel layer is approximately 20 to 40 microns thick.

12. A screening mask comprising:
a molybdenum foil core; and
a nickel layer on each of said molybdenum foil core.

13. The mask of claim 12 including at least one partial cavity defined by at least one etch process through at least a portion of said molybdenum foil core.

14. The mask of claim 12 including at least one through-hole cavity defined by at least one etch process through said molybdenum foil core, and at least one partial cavity defined by at least one etch process through at least a portion of said molybdenum foil core.

15. A method of making a screening mask comprising:
bonding a copper layer to both sides of a molybdenum foil;
patterning said copper layers with a photoresist;
electroplating nickel into open areas between said patterned photoresist;
striping said photoresist, leaving said electroplated nickel in a patterned sequence, said patterned sequence representing a predetermined pattern for said screening mask;
removing portions of said copper layers between said nickel plating; and
removing portions of said molybdenum foil.

16. The method of claim 15 wherein said copper layers are removed by a selective copper etchant, said copper etchant including ammonium chloride and cupric chloride basic solution.

17. The method of claim 15 wherein said molybdenum foil is removed by a selective molybdenum etchant, said molybdenum etchant including a potassium ferricyanide basic solution.

18. The method of claim 15 wherein said copper layers are bonded to said molybdenum foil by hot rolling, metal evaporation, electroplating, or explosive plating.

19. The method of claim 15 further including cleaning said copper layers using a commercial detergent.

20. The method of claim 15 further including a second photolithographic step to block removal of said copper layers in desired locations.
